(19) United States
(12) Patent Application Publication
(10) Pub. No.: US 2013/0298840 A1
(43) Pub. Date: Nov. 14, 2013

(54) PET URINAL

(71) Applicant: ISAAC MISHAN, New York, NY (US)

(72) Inventor: ISAAC MISHAN, New York, NY (US)

(21) Appl. No.: 13/469,916

(22) Filed: May 11, 2012

(51) Int. Cl. A01K 29/00

(52) U.S. Cl. 119/165

(57) ABSTRACT

A toilet for an animal includes a porous mat that animals may stand on and which urine may pass through and a sloped surface adapted to channel urine toward a drain opening for collection in a collection receptacle. The porous mat is supported by the coplanar flat top surfaces of a plurality of posts protruding upwardly from, and spaced along, the sloped surface.

### FIELD AND BACKGROUND OF THE INVENTION

The present invention relates to the field of pet toilets, and in particular to pet urinals having porous, synthetic grass surfaces for pets to stand on and to relieve themselves on.

Household pets such as cats and dogs need to relieve themselves on a regular basis. This can be a difficulty when pets live in places such as apartments where no back yard is available or when pets are not allowed outside. This can be particularly difficult when pet owners must be away from home for long periods at a time and the pet is confined indoors alone. Various pet toilets have been implemented to deal with this difficulty, such as cat litter boxes lined with absorbent materials and disposable absorbent “wee wee pads” placed on home floors.

One problem with these approaches is that the pet typically needs to step on the same surface where urine is deposited. If they are not replaced or refreshed constantly, the pet may step on excrement left in the litter box or on the pad by another pet, or on a previous visit. This can contribute to a hygienic hazard if the pet then walks around the home with soiled feet.

Another problem is that litter boxes are not generally appropriate for dogs, and that pets may come in direct contact with waste when using litter boxes. A further problem is that some pets will not consistently use “wee wee pads” for relieving themselves because they do not look like the outdoor spaces where they are accustomed to relieving themselves. Wee wee pads also may become saturated when used repeatedly or by larger pets, leading to spillage of urine and/or to pets stepping in urine.

Others have attempted to address these problems by providing indoor pet toilets including porous synthetic grass. See, e.g., U.S. Pat. No. 7,584,717 (“Skovron”). Some of these devices, however, do not provide an even, flat surface for pets to stand on (e.g., Skovron Col. 2 lines 55-60, Col. 4 lines 23-26, Col. 5 lines 16-18, 26-33). Skovron, for example, discloses a porous synthetic grass surface resting directly on top of corrugations that are part of a sloped surface (Col. 5, lines 28-33, FIGS. 8-11). Pets may be less inclined to stand on and use uneven, sloped surfaces, or else pets may be less stable and comfortable when doing so.

Some devices provide porous “grass” surfaces that rest in, on, or extremely near areas where urine collects and/or that urine drains through (e.g., Skovron Col. 2 lines 55-60, Col. 4 lines 23-26, Col. 5 lines 16-18, and Skovron FIGS. 10-11). Skovron, for example, discloses synthetic grass resting directly on top of ridges between very shallow troughs which are intended to channel pet urine. This creates a hygienic hazard and makes it more likely that pets will get urine on their feet that will be spread through the home, and more likely that the grass surface will become and remain wet.

Still other pet toilets that might provide flat porous “grass” surfaces rest those surfaces on top of planar supports that, in turn, are only supported at their margins (Skovron Col. 4 lines 12-16). This is analogous to putting the grass on a mesh screen that is placed on top of a large mixing bowl. As a result, such toilets may not be appropriate or safe for use by larger dogs because the flat grass surface, resting on a planar support that is supported only at its margins, could sag or break under larger dogs' weight. At minimum, only supporting the flat grass surface near its margins, and not closer to the center, dictates and limits the designs and materials that may be used to build flat-topped pet toilets of this general type. Alternative, stronger designs that support flat porous surfaces beyond their margins would be advantageous.

It is generally desirable to have pet toilets that solve or ameliorate the above-mentioned problems, or that at least constitute additional useful alternative designs. It is particularly desirable to provide a synthetic grass covered pet toilet that provides a substantially flat surface for pets to stand on, that provides a gap between the grass surface that pets stand on and the surfaces that collect and drain urine, and that is strong enough to hold larger pets safely above collecting and draining urine.

### SUMMARY OF THE INVENTION

It is an object of the present invention to provide a toilet or urinal for use by pets that includes a permeable surface that a pet can comfortably stand on and that allows urine to drain through to a sloped surface below, wherein the sloped surface is preferably non-permeable and directs urine towards a drain opening, wherein urine reaching the drain opening is received by and stored by a collection receptacle, and wherein the permeable surface is supported by a plurality of posts extending upward from the sloped surface.

Preferably, the permeable surface resembles green grass.

Preferably, the permeable surface provides a flat, level surface that pets can comfortably stand or squat on while relieving themselves.

Preferably, the posts hold the permeable surface up and away from draining urine and from the sloped surface which collects and directs urine towards the drain opening.

Preferably, the posts support substantially all of the permeable surface, utilizing posts positioned both near the permeable surface's center and near its periphery, with sufficient strength to support and accommodate large, heavy pets.

Preferably, the collection receptacle comprises a waste drawer that removably slides in and out of the toilet.

Preferably, the toilet is adapted so that a plurality of toilets can be joined together to form a larger, essentially continuous toilet surface.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a top perspective view of a pet urinal with a mat of porous artificial grass in place;

FIG. 2 is view similar to FIG. 1, but with the grass mat removed;

FIG. 3 is a sectional view of the pet urinal taken along line 3-3 depicted in FIG. 1;

FIG. 4 is a bottom perspective view of the pet urinal with the drawer partially open;

FIG. 5 is a top plan view of the urinal with the grass mat removed.

FIG. 6 is a close-up, partial, top perspective view of two pet urinal frames positioned so that a linking clip may be inserted into respective linking slots to join the frames to form a larger pet urinal;

FIG. 7 is a close-up, partial, bottom perspective view of the two linked pet urinal frames of FIG. 6; and

FIG. 8 is a top perspective view of two pet urinal frames joined together by two linking clips.

### DESCRIPTION OF THE PREFERRED EMBODIMENTS

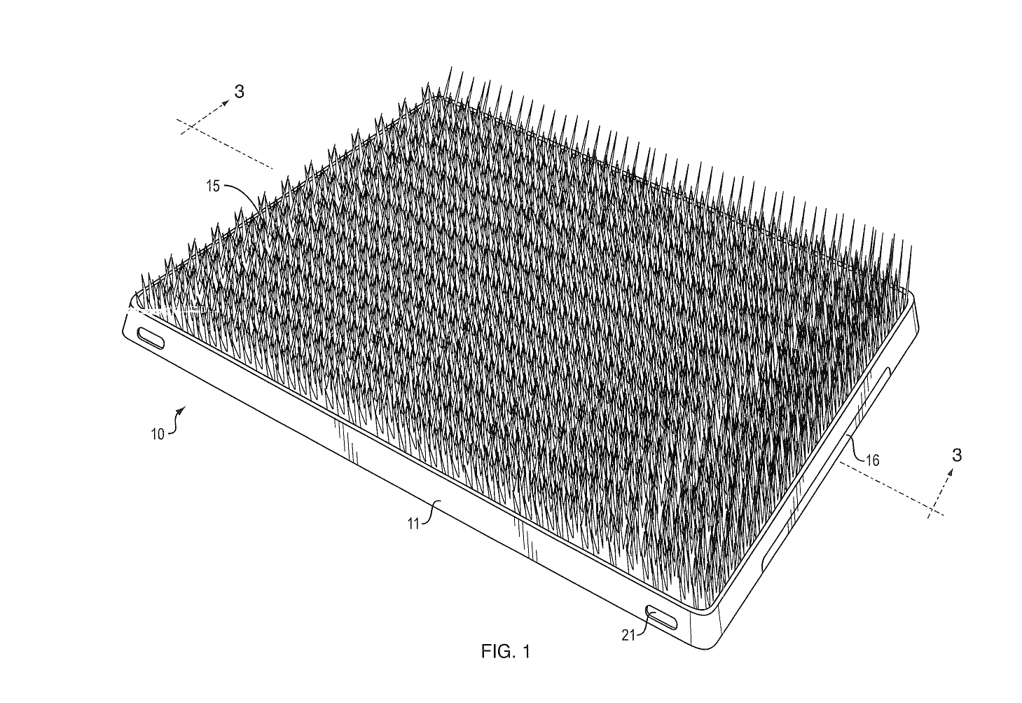

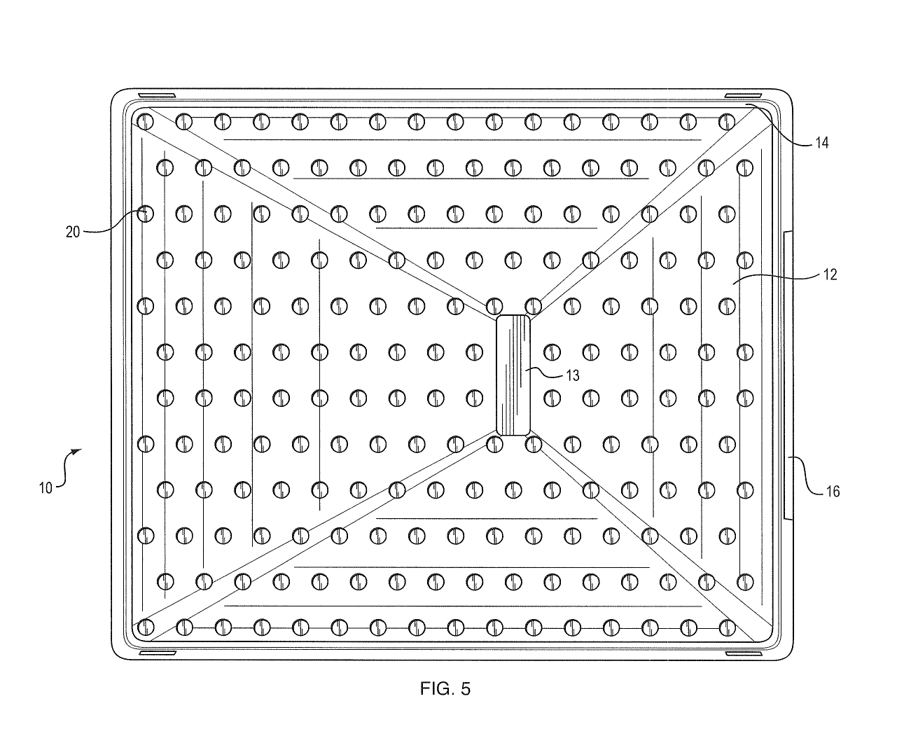

Referring now to the drawings, in which like reference numerals are used to refer to the same or similar elements, FIGS. 1 through 5 show a preferred embodiment of the pet toilet or urinal, generally depicted at 10, of the present invention.

The toilet 10 is suitable for use by, for example, animals such as dogs and cats. The portable toilet 10 as a whole may be essentially any shape including, for example, square, round or rectangular. Preferably, the toilet is generally a rectangular box. The toilet is appropriate for use both indoors and outdoors.

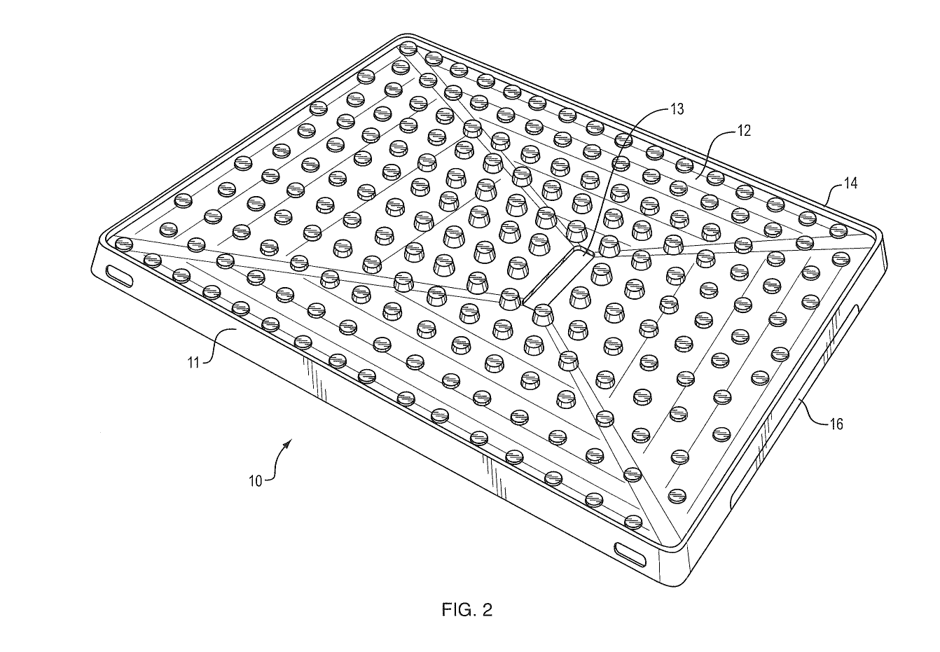

Typically and preferably, an animal will be trained to urinate on a porous mat 15 of artificial grass that makes up most or all of the top surface area of the toilet 10, the mat 15 being positioned over the a plastic frame 11. In the preferred embodiment the porous mat 15 resembles green grass. The porous quality of the porous mat 15 allows urine to pass through it and fall onto a sloped surface 12 of the frame 11 in FIG. 2, which is generally below that mat 15, and which funnels the urine towards a drain opening 13 and then into a collection receptacle 16.

The toilet 10 includes the sloped surface 12 that is generally upward-facing and is shaped so that urine or other liquids that reach its surface will, by gravity, be funneled and directed generally towards one or more drain openings 13. In a preferred embodiment the sloped surface 12 is evenly and gradually sloped throughout. Alternatively, the surface may have varying degrees of slope. Further alternatively, the sloped surface 12 may be rounded, planar, generally concave, and/or may include channels or gullies.

In a particularly preferred embodiment as shown in FIG. 2, the sloped surface 12 has nearly the same diameter or two-dimensional dimensions as the overall toilet 10. In this embodiment the drain opening 13 is a hole in the sloped surface located just off of the center of the sloped surface 12 and at is lowest point. The sloped surface 12 preferably slopes down from a raised perimeter 14 of the toilet 10, towards the drain opening 13. Urine falling on any part of the sloped surface is naturally directed downhill towards the opening in a manner analogous to a funnel.

The sloped surface 12 includes a plurality of posts 20 extending generally upward from the surface 12. In a preferred embodiment, the posts 20 are substantially flat on top, and the flat surfaces at the top of the posts are preferably level and coplanar with each other.

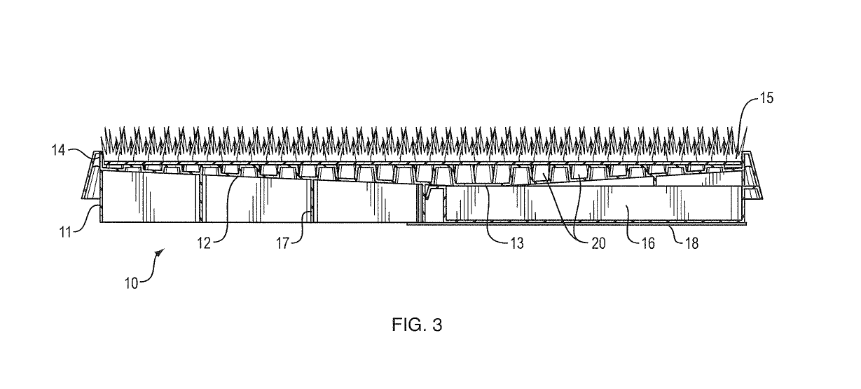

It will be appreciated that, in order for the tops of the posts to be coplanar, some posts 20 positioned at the lower portions of the surface 12 will be taller than other posts positioned at higher areas of the surface to compensate for the varying elevations in different areas of the sloped surface 12. This is illustrated at, for example, FIG. 3.

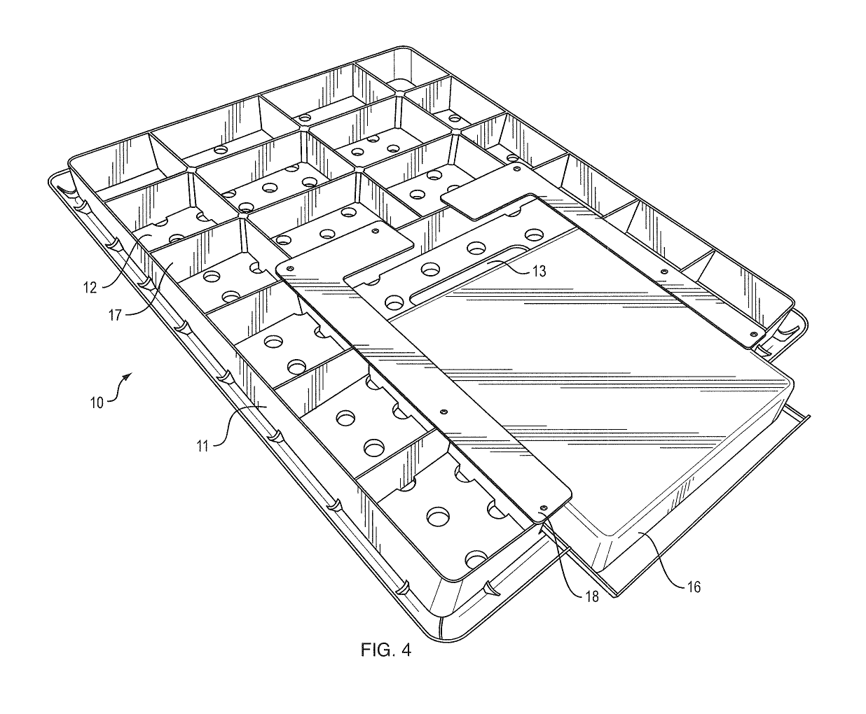

The posts 20 of this invention may be a variety of shapes such as, for example, round columns, square columns, or variations of pyramids or cones. The posts may be made of any material having at least moderate rigidity or resilience. Preferably the posts comprise non-permeable, washable materials such as metal, plastic, stone or rubber. Persons of skill in the art will be able to select shapes and materials for the posts appropriate for various applications and designs. The posts 20 may be hollow as shown in FIGS. 3 and 4 in order to make the toilet lighter and to reduce the amount of material used in manufacture.

The posts 20 are arranged so that urine may flow past and around them on the sloped surface 12 and towards one or more drain openings 13.

In a preferred embodiment the sloped surface 12 may be surrounded by a perimeter or ridge 14 or other barrier that prevents urine from moving in any direction other than towards the drain opening 13. Optionally, the ridge 14 may also function to define a space that the synthetic grass mat 15, or a structure that supports the synthetic grass surface, fits and rests in. Alternatively, such ridge may help to support the synthetic grass surface 15 from an inferior position.

One or more drain openings 13 are positioned so that urine and other liquids drain through the openings into one or more collection receptacles 16. In a preferred embedment, a single drain opening 13 consists of a hole at or near the center of the sloped surface 12 at the lowest point of the sloped surface. Alternatively, one or more drain openings 13 may be located at or near an edge or corner of the sloped surface 12. Drain openings 13 may be either openings in the sloped surface 12 or may be an edge of a sloped surface where liquids may drain off of the sloped surface.

One or more collection receptacles 16 are positioned to receive and collect urine draining from the sloped surface 12 through one or more corresponding drain openings 13. In a preferred embodiment, there is only one collection receptacle 16, which receptacle may be easily removed like a drawer from the rest of the toilet 10 for emptying and cleaning. In FIGS. 2 and 4 the receptacle drawer is depicted partially open.

The collection receptacle 16 may sit within, adjacent to, or under the frame 11 of the portable toilet 10. Preferably the collection receptacle fits entirely or almost entirely within or under the toilet frame 11, but is also easy to locate and remove when desired. Preferably the receptacle 16 sits on top of supports 18, such as flat plates or rails, adapted to hold the receptacle in a position to receive urine from the drain opening 13, and further adapted to allow the receptacle to slide or move over the supports 18 and out of the toilet 10 for emptying. Preferably the collection receptacle 16 includes a handle, rims or other means for pulling the receptacle in and out of the toilet and/or for carrying the receptacle when it has been removed from the toilet for emptying.

In a particularly preferred embodiment the collection receptacle 16 resembles a rectangular drawer with an open top and is housed in the side of the toilet 10, the receptacle 16 resting on supports 18 which are attached to the bottom on the toilet 10, the receptacle 16 removably sliding in and out of the portable toilet 10 on top of the supports 18 for inspection and emptying. Preferably, the collection receptacle has sufficient capacity so that it will not overflow even after the portable toilet has been used several times.

The sloped surface 12 and collection receptacle 16 preferably comprise materials that are not porous or otherwise significantly permeable to liquids. Preferably the sloped surface and collection receptacle are made from washable materials. The sloped surface 12 may, optionally, also be removable from the rest of the toilet 10 for easier cleaning. The sloped surface and the collection receptacle may, without limitation, be made from plastic or metal.

Preferably the sloped surface will be constructed, supported, and reinforced so as to lend strength and stability to the toilet frame 11 and to the posts 20. In a preferred embodiment the frame 11 generally, and the underside of the sloped surface 12 in particular, comprise rigid bracing structures 17 adapted to increase the strength and weight-bearing capacity of the pet urinal 10. In one preferred embodiment the bracing structures 17 comprise a grid pattern of perpendicular walls positioned below and fused to the sloped surface 12, and also fused to the inside periphery of the frame 11, as illustrated in FIGS. 3 and 4. The bracing structures may comprise the same material as the frame 11 and sloped surface 12, and preferably are a part of a single unitary object also comprising the frame and sloped surface. Alternatively, the bracing structures may be made from different materials as, and/or may be separate components from, the frame 11 and the sloped surface 12.

In one application of the invention, a family dog can be trained to go to the toilet on the porous mat 15 of the present invention, which porous surface preferably resembles grass.

The porous surface or mat 15 removably rests directly or indirectly on top of the posts 20. The porous surface 15 is a surface that pets may comfortably stand on and that urine may drain through. Preferably, the porous surface 15 resembles grass or turf, though surfaces that do not resemble grass or turf also fall within the scope of this invention. In a preferred embodiment the porous surface 15 comprises synthetic plastic grass that is comfortable to stand on, that resembles outdoor grass that pets may be accustomed to urinating on, and that provides traction for the animal. In a further preferred embodiment the porous surface is made of a material that is easily washable and/or that is inexpensive and disposable.

The porous surface 15 preferably has the same approximate surface area and shape as the sloped surface 12. It will be understood that the porous surface may comprise a variety of materials, such as, but not limited to, real grass, disposable natural products, and synthetic materials that do not resemble grass.

The porous mat 15 may be either rigid or flexible. The porous surface 15 may, optionally, be supported or reinforced by another structure such as, for example, a porous screen, board, or mesh positioned between the porous surface and the posts 20 below. The porous surface may have one or more than one layer.

Optionally, the porous surface 15 may be removably attached to another part of the toilet frame 11 such as by snaps, straps, hook-and-loop fasteners, buttons, or other means. In one embodiment the porous surface may be attached to the toilet along only one edge so that the porous surface may be pivotally lifted up off of the posts like a door or a hatch. Optionally the porous surface may have handles, straps or other means to easily lift and move the surface with reduced contact with animal waste.

As mentioned, the porous mat 15 is removably positioned so that a pet may relieve itself while standing, squatting, or otherwise positioned over the porous surface. The porous surface or mat 15 is located generally above the sloped surface 12 so that urine draining through the porous surface will arrive on the sloped surface. The porous mat 15 is supported by the posts 20. Preferably the posts hold the mat 15 so that the mat is above and does not come into significant contact with the sloped surface 12, or with urine collecting on and/or draining from the sloped surface. In a preferred embodiment, the posts 20 will support the mat 15 such that the porous surface 15 is substantially flat and horizontal.

To this end, the total area of the tops of the posts 20 on the sloped surface 12 preferably amount to about 10 to 20% of the total area of the surface 12, and more preferably about 12 to 16%. The posts 20 are preferably evenly spaced across the surface 12 and preferably in a diamond pattern.

The plural posts of this invention are particularly useful for supporting a less-rigid porous surface, such as soft synthetic grass, in a flat position that is above and away from urine. A large number, e.g., 100 to 300 (preferably 190), of evenly-spaced posts 20 having relatively flat tops are particularly suitable for this purpose, as exemplified in FIG. 2.

In the preferred embodiment (FIGS. 1 and 2) the entire porous mat 15 is directly supported in a planar, horizontal position by flat-topped posts 20 arranged so as to support the porous mat 15 throughout its area without leaving any large unsupported portions. One purpose of this configuration is to provide strong support to the entire porous surface to keep it both substantially flat and generally separated from the sloped surface 12. An advantage of this configuration is that the porous surface, and animals standing on the porous surface, are held above the urine collecting and flowing on the sloped surface 12 below so that they can remain relatively dry. This constitutes an improvement over prior art toilets where the porous surface, such as fake grass, is not held substantially apart from surfaces where urine flows and collects.

Another advantage of this embodiment is that it provides a flat, horizontal surface for pets to stand on while relieving themselves. This is an improvement over prior art toilets where the porous surface that pets stand on is sloped or irregular because flat, level surfaces may be easier and more comfortable for pets to stand or squat on.

Another purpose of the preferred configuration above is to better support heavier animals while keeping them separated from the urine on the sloped surface 12. Prior art toilets have employed porous synthetic grass arranged on top of a generally planar perforated surface placed over a concave urine collecting surface (e.g., Skovron, Col. 4 lines 12-16). This is apparently analogous to placing a mesh screen on top of a bowl. These toilets rely on the strength and rigidity of the supporting planar porous surface, supported only near its periphery, to hold the synthetic grass flat and separated from the concave urine collecting surface below, even when animals are standing on top of the porous surface.

These prior art toilets do not provide posts or other structures to support a horizontal porous surface, above a concave sloped surface, throughout its area. Such art toilets have the disadvantage of being structurally weak because they lack support closer to the center of the porous grass surface. This weakness could contribute to animals falling through or breaking the porous surface. Alternatively, toilets using the prior art design may have to be built with heavier or more expensive materials to compensate for the lack of support away from the periphery of the porous mat or surface 15 and/or away from the periphery of a horizontal surface the porous surface rests on.

The present invention, in contrast, provides posts 20 that can be arranged to support the porous mat 15 not only at its periphery, but also near its center and in any other location a person of skill in the art might deem them necessary to provide strength and stability. This provides clear advantages over the prior art, especially when designing flat-surfaced toilets for use by larger and heavier animals.

For example, a plurality of posts 20 arranged to support both the periphery of a porous surface, and areas further from the periphery, can support a porous surface 15 above and away from a sloped surface 12 without the need for an additional rigid element as described in the prior art. FIGS. 1-3. The posts can also provide stronger support for porous surfaces 15, as well as for any intermediate rigid element, than prior art systems that only provide for support from the edges. The plural columns of the present invention also allow more flexibility in designing pet toilets having porous surfaces held up away from urine funneling and collecting surfaces.

The number and positioning of posts 20 necessary to adequately support the porous mat or surface 15 will depend on a number of factors such as, without limitation, the area of the sloped surface and of the porous surface, the size, shape and strength of the posts, the properties of the porous surface, the stiffness or flexibility of the porous surface, the presence or absence of a rigid structure supporting the porous surface, and the desired weight capacity of the toilet. It is within the abilities of one skilled in the relevant art to determine proper arrangements of posts for various applications without undue experimentation.

In one illustrative embodiment, round, flat-topped posts, about ⅝ inches in diameter and comprised of a strong plastic, are arranged in staggered rows spaced approximately 1 ro 2 inches apart on centers. The sloped surface 12 is, in this example, about 18 inches by 23 inches and rectangular. In this case with evenly spaced posts 20 having about 1.5 ro 1.75 inch spacing, each post with an area of about 0.3 square inches, includes and accounts for about 14% of the area of the sloped surface 12. This arrangement is sufficient to support a synthetic grass surface with moderately strong stiffness as well as most dogs. Alternative embodiments having, for example, a larger total surface 12 area, more posts 20, and/or posts with a greater diameter, could be employed to accommodate larger pets.

The toilet 10 may be a variety of sizes tailored to pets and homes of varying dimensions. In another illustrative embodiment, the portable toilet is approximately 22 inches by 20 inches for use by a small dog. In another illustrative embodiment, a toilet adapted for larger spaces and larger dogs is 36 inches square. The toilet 10 is preferably easily portable, though this invention is not limited to toilets of any particular size.

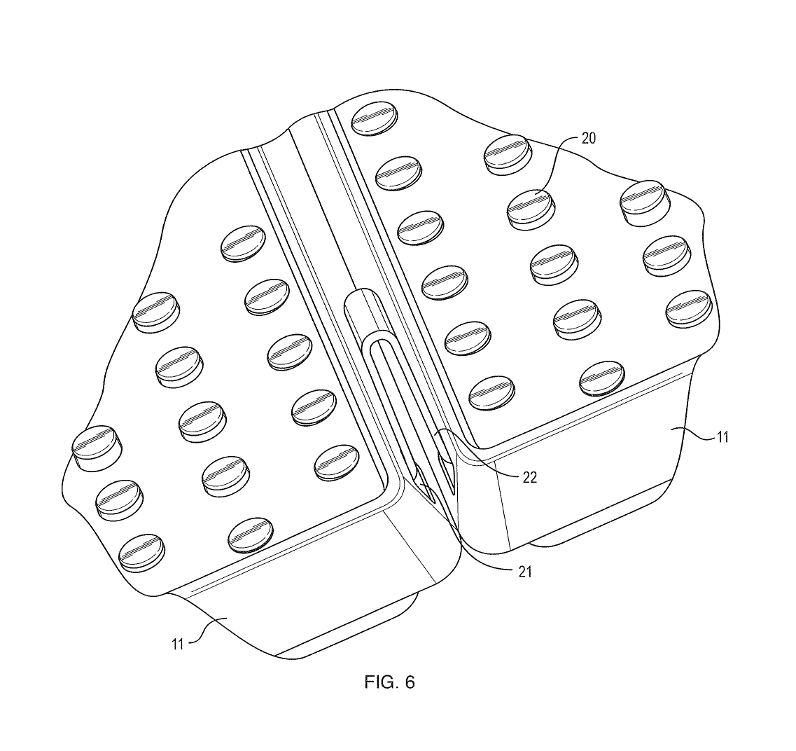

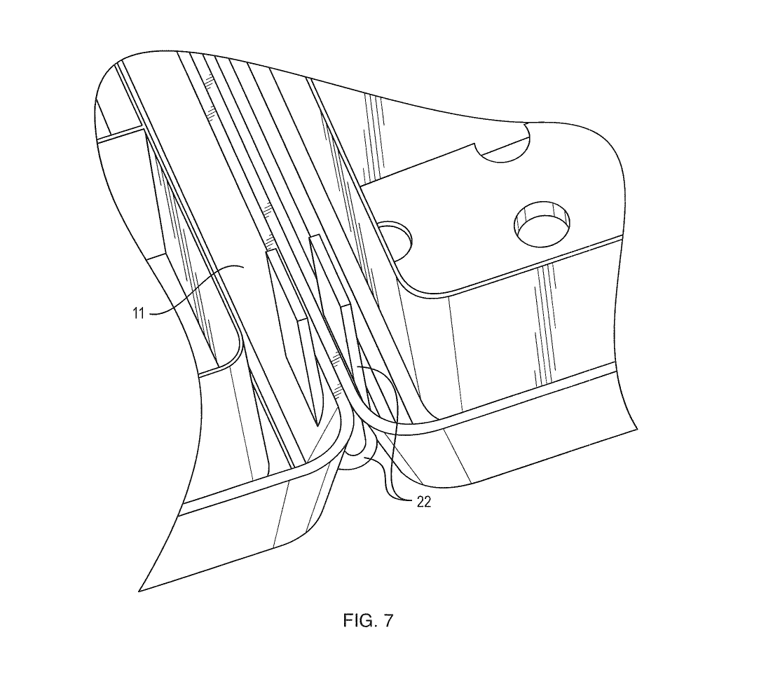

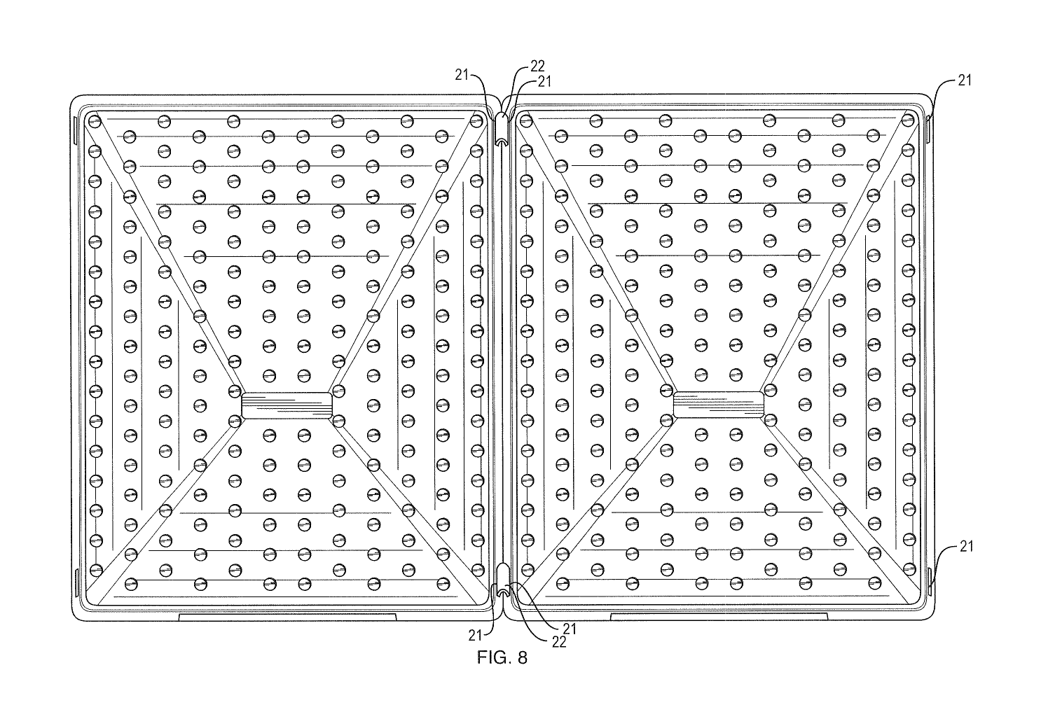

A plurality of pet urinal frames 11 can be joined together to form a single larger surface for larger dogs, or for multiple dogs as shown in FIGS. 6 to 8. To this end, the front and rear long sides of frame 11 each include one, two or more linking slots 21. Preferably, both sides of the frame 11 have two outwardly-facing linking slots 21 spaced apart as depicted in FIG. 8. Generally U-shaped linking clips 22 of resilient material such as strong plastic or spring steel are used to link two or more frames 11 together by being inserted into the adjacent slots 21 of the two frame 11 after they have been placed next to each other as shown in FIG. 8. This is achieved by arranging toilet frames 11 so that corresponding linking slots 21 are across from and near each other, and inserting the free ends of linking clips 22 down into the corresponding linking slots 21 of the frames to be joined together. The sides of two toilet frames 11 may be joined at their edges utilizing two U-shaped linking clips 22 and a total of four linking slots 21.

Persons of skill in the art will recognize that linking slots 21 may be arranged in a variety of configurations to allow connection of toilets on various sides and in various arrangements. Linking clips 22 that are other than U-shaped are also within the scope of the invention. It will be appreciated that toilets may be joined together using means other than linking slots and linking clips.

While specific embodiments of the invention have been shown and described in detail to illustrate the application of the principles of the invention, it will be understood that the invention may be embodied otherwise without departing from such principles.

What is claimed is:

1. A pet urinal comprising:
a rigid frame having an upper sloped surface, said sloped surface shaped and positioned to funnel urine from a pet towards a drain opening in the sloped surface;
a collection receptacle engaged to the frame and positioned under the sloped surface and under the drain opening for receiving pet urine passing through said drain opening;
a plurality of posts projecting upwardly from said sloped surface, each post having a substantially flat top surface, with all the top surfaces of the posts lying in a common horizontal plane;
a porous mat supported on said posts, the porous mat being removably positioned above and of a size to cover the sloped surface;
wherein the porous mat and the spaced posts under the mat are adapted to support a pet, and the porous mat is adapted to pass urine there-through onto the sloped surface.

2. A pet urinal as claimed in claim 1, wherein the posts hold the porous surface above and substantially not in direct contact with the sloped surface.

3. A pet urinal as claimed in claim 1, wherein the porous mat is arranged in a flat and horizontal position.

4. A pet urinal as claimed in claim 1, wherein the porous mat comprises synthetic grass.

5. A pet urinal as claimed in claim 1, wherein the collection receptacle can be removed for emptying and is mounted for horizontally sliding into and out of the frame.

6. A pet urinal as claimed in claim 1, further comprising a raised perimeter surrounding the sloped surface.

7. A pet urinal as claimed in claim 1, further comprising a raised perimeter surrounding the sloped surface and wherein the raised perimeter defines a space where the porous mat is positioned.

8. A pet urinal as claimed in claim 1, wherein at least a portion of each post has a substantially round cross-section.

9. A pet urinal as claimed in claim 1, wherein the posts are frusto-conical.

10. A pet urinal as claimed in claim 1, wherein the posts are sufficient in number and strength to support the porous mat above the sloped surface in a substantially flat position with a dog of up to 100 pounds standing on the porous surface.

11. A pet urinal as claimed in claim 1, wherein the posts are evenly spaced throughout substantially all of the sloped surface.

12. A pet urinal as claimed in claim 1, wherein the porous mat is a disposable mat of artificial turf.

13. A pet urinal as claimed in claim 1, wherein the sloped surface comprises a material selected from the group consisting of metal and plastic.

14. A pet urinal as claimed in claim 1, wherein the flat tops of the posts collectively account for between 10 and 20 percent of the total area of the sloped surface.

15. A pet urinal as claimed in claim 1, wherein the flat tops of the posts collectively account for between 12 and 16 percent of the total area of the sloped surface.

16. A pet urinal as claimed in claim 1, wherein one or more posts are located closer to the center of the sloped surface than to a nearest edge of the sloped surface.

17. A pet urinal as claimed in claim 1, wherein each post is separated from the nearest neighboring post by no more than two inches.

18. A pet urinal as claimed in claim 1, wherein each post is hollow.

19. A pet urinal as claimed in claim 1, including a bracing structure connected to the frame below the sloped surface to increase the weight bearing capacity of the sloped surface.

20. A pet urinal as claimed in claim 1, including at least one support fixed to the frame, said support being adapted to removably support the collection receptacle below the sloped surface in a position where the collection receptacle will receive urine passing through the drain opening.

21. A pet urinal as claimed in claim 1, comprising at least one linking slot in at least one side of the frame, and at least one clip for insertion into the at least one linking slot for removably attaching the frame to a second frame having at least one linking slot in at least one side of the second frame for also receiving the clip for linking the first-mentioned and second frames together.

22. A pet urinal as claimed in claim 21, wherein the linking clip is U-shaped.

23. A pet urinal as claimed in claim 21, further comprising two of the linking clips and the second frame, the first-mentioned and second frames each being rectangular and each having linear facing sides with two of said locking slots in each facing side, wherein the locking slots and clips received therein removably link the frames to each other along their respective linear facing sides with the two linking clips to form a single substantially continuous surface for supporting a pet.
